(19) United States
(12) Patent Application Publication
(10) Pub. No.: US 2011/0305012 A1
(43) Pub. Date: Dec. 15, 2011

(54) BEAM ANGLE ADJUSTABLE LIGHT-EMITTING DIODE LAMP

(75) Inventor: Chao-Wen LO, Keelung (TW)

(73) Assignee: BESTDISC TECHNOLOGY CORP., Keelung (TW)

(21) Appl. No.: 13/108,785

(22) Filed: May 16, 2011

(30) Foreign Application Priority Data
Jun. 14, 2010 (TW) 099211314

(51) Int. Cl. F21V 29/00

(52) U.S. Cl. 362/218

(57) ABSTRACT

A beam angle adjustable LED lamp has a simicircular and tubular heat-dissipating body, a light source module mounted on the heat-dissipating body to constitute a thermal contact therewith, a contact module pivotally mounted on one end of the heat-dissipating body, and a power converter mounted inside the heat-dissipating body and respectively and electrically connected with the light source module and the contact module. With the foregoing structure, a lighting direction of the light source module is perpendicular to an electrical connection path of the contact module and a lamp socket. As the contact module is pivotable relative to the heat-dissipating body, a beam angle of the light source on the heat-dissipating body can be adequately adjusted based on a lighting requirement.

### BACKGROUND OF THE INVENTION

1. Field of the Invention

The present invention relates to a light-emitting diode (LED) lamp, and more particularly to an LED lamp capable of conveniently adjusting a lighting direction.

2. Description of the Related Art

In answer to the global pursuit of carbon reduction and energy conservation, light-emitting diode has become a dominant light source considered for lamps lately. In contrast to conventional light source, LED lamps remarkably differ in power specifications and driving means. Even so, in order to sufficiently utilize current resources, stimulate customers' intention to replace conventional light sources and increase the applicable range of LED lamps, LED lamps tend to be designed and made compatible with conventional lighting equipment, for example, LED lamps having the forms of incandescent bulbs or fluorescent lamps, during a commercialization process of LED lamps.

For one kind of LED lamps currently available in the market taking the form of a light bulb and having their ring contacts connected with the lamp sockets of the conventional incandescent lamps, the lighting angle of such an LED lamp may not be properly positioned as intended after the ring contact of the LED lamp is tightly screwed into the lamp socket due to the unmatched tolerances thereof. The deviated lighting angle simply leads to an unsatisfactory light effect.

Besides, despite the advantages of low power consumption and long working cycle, heat generated by LED lamps using multiple LEDs to simultaneously illuminate must be tackled with an efficient heat-dissipating approach. Most LED lamps currently employ die-casting parts for heat dissipation. However, the die-casting parts are implemented with higher cost. Additionally, LED lamps with different power consumption need to have corresponding heat-dissipating requirements. In other words, die-casted heat-dissipating parts with different specifications must be prepared to comply with the power consumption requirements of the LED lamps, and such necessity significantly increases the cost of the LED lamps.

### SUMMARY OF THE INVENTION

An objective of the present invention is to provide a beam angle adjustable LED lamp capable of conveniently adjusting a lighting direction.

To achieve the foregoing objective, the beam angle adjustable LED lamp has a heat-dissipating body, a light source module, a contact module and a power converter.

The heat-dissipating body is tubular and composed of an extrusion, and has a platform and a chamber. The platform is formed on a periphery of the heat-dissipating body and has a surface. The chamber is defined by the heat-dissipating body and located under the platform.

The light source module is mounted on the platform of the heat-dissipating body to constitute a thermal contact with the surface of the platform.

The contact module has an insulation base and a ring contact. The insulation base is pivotally mounted on one end of the heat-dissipating body. The ring contact is mounted around the insulation base.

The power converter is mounted inside the chamber of the heat-dissipating body, and has one set of input wires and one set of output wires. The set of input wires is electrically connected to the ring contact. The set of output wires is electrically connected to the light source module.

In the foregoing structure a lighting direction of the light source module is approximately perpendicular to the contact module. As the contact module is pivotable relative to the heat-dissipating body, a beam angle of the light source on the heat-dissipating body is not affected by the tolerance or tightness between the LED lamp and a lamp socket, and can be adequately adjusted based on a lighting requirement.

Another objective of the present invention is to provide an LED lamp commensurate with different heat-dissipating requirements. The LED lamp employs a heat-dissipating body composed of extruded aluminum. When the LED lamp has higher power consumption, the LED lamp just needs to increase the length of the heat-dissipating body to obtain more heat-dissipating area and satisfy the heat-dissipating requirements under different power consumption.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a beam angle adjustable LED lamp in accordance with the present invention;

FIG. 2 is an exploded perspective view of the beam angle adjustable LED lamp in FIG. 1;

FIG. 3 is a side view in partial section of the beam angle adjustable LED lamp in FIG. 1;

FIG. 4 is a front view in partial section of the beam angle adjustable LED lamp in FIG. 1; and

FIG. 5 is an exploded perspective view of another embodiment of the light source module and extruded heat-dissipating body of the beam angle adjustable LED lamp in FIG. 1.

### DETAILED DESCRIPTION OF THE INVENTION

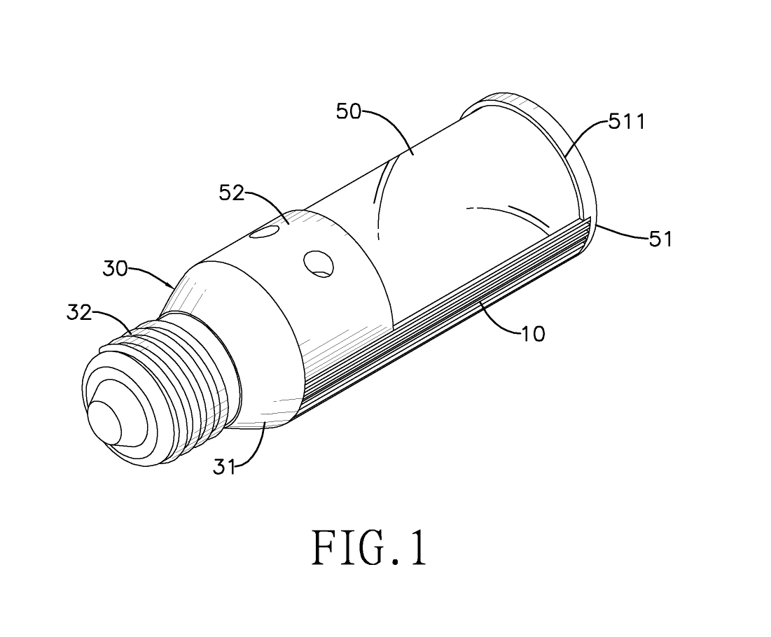

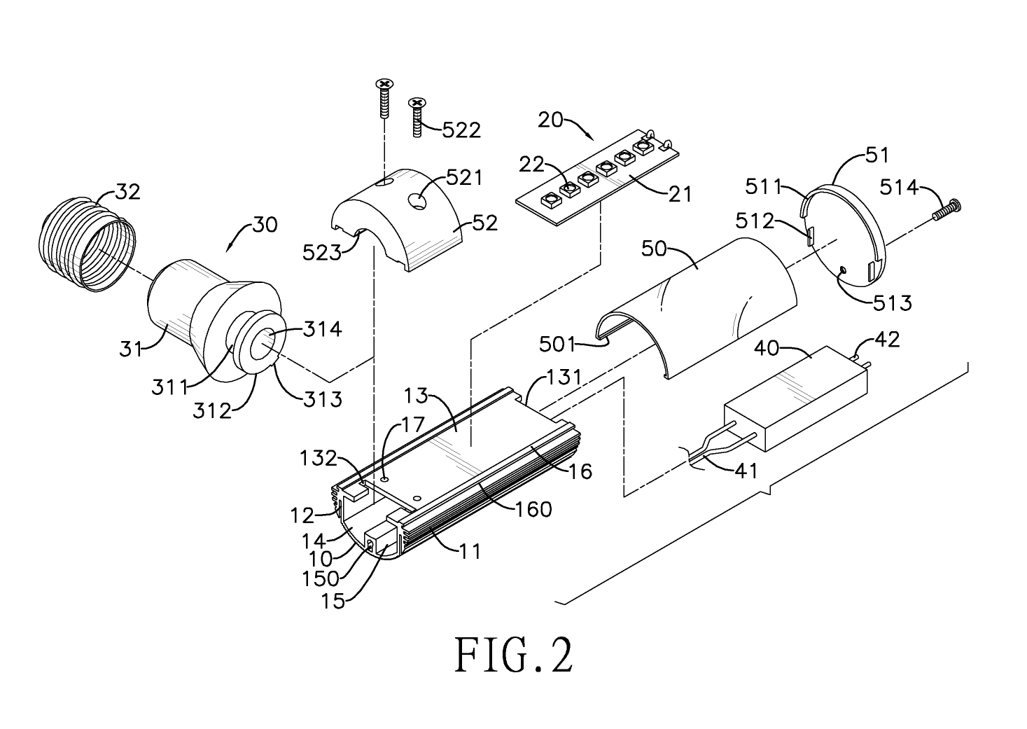

With reference to FIGS. 1 and 2, a beam angle adjustable LED lamp in accordance with the present invention has a heat-dissipating body 10, a light source module 20, a contact module 30 and a power converter 40, a lamp shade 50, a first fixing member 51 and a second fixing member 52.

The heat-dissipating body 10 is composed of an extrusion by a continuous extrusion process. After a length of extruded aluminum constituting the heat-dissipating body 10 is extruded, the heat-dissipating body 10 is cut to a preset length based on an actual power requirement of the LED lamp.

In the present embodiment, the heat-dissipating body 10 is tubular, and has a semicircular section, multiple fins 11, two notches 12, a platform 13, a chamber 14, a stop bar 15, two guide strips 16 and at least one positioning hole 17. The fins 11 are oppositely and longitudinally formed on and transversely protrude from a semicylindrical periphery of the heat-dissipating body 10 so as to increase a heat-dissipating area. The two notches 12 are oppositely and longitudinally formed in inner portions of the fins 11. The platform 13 is formed on a periphery of the heat-dissipating body 10, and has a cavity 131 and an opening 132. The cavity 131 is formed on and recessed inwardly from a first end of the platform 13. The opening 132 is formed through an opposite second end of the platform 13, is T-shaped, and has a transverse slot and a longitudinal slot. One end of the longitudinal slot communicates with the transverse slot, and the other end is formed through an edge of the second end of the platform 13. The chamber 14 is defined inside the heat-dissipating body 10 for accommodating the power converter 40. The stop bar 15 is longitudinally formed on and protrudes from a bottom of an inner wall of the heat-dissipating body 10, and has a through hole 150 longitudinally formed through the stop bar 15 for fixing the first fixing member 51. The guide strips 16 are respectively and longitudinally formed on two sides of the platform 13 along the transverse direction, and have two channels 160 respectively and longitudinally formed in two opposite sidewalls of the guide strips 16 for engaging the lamp shade 50. The at least one positioning hole 17 is formed through the platform 13 and adjacent to the opening 132 for fixing the second fixing member 52.

The light source module 20 has a circuit board 21 and multiple LEDs 22. The circuit board 21 is elongated and mounted on the platform 13 of the heat-dissipating body 10 to constitute a thermal contact with a surface of the platform 13. The LEDs 22 are mounted on the circuit board 21. When the light source module 20 is operating, heat generated from the circuit board 21 is conducted to the platform 13 and radiated to the air through the semicylindrical periphery of the heat-dissipating body 10 and the fins 11 on the heat-dissipating body 10. An operating power of the light source module 20 is supplied by the power converter 40.

The power converter 40 has one set of input wires 41 and one set of output wires 42. The set of output wires 42 is electrically connected with the circuit board 21 of the light source module 20 through the cavity 131 of the platform 13. The set of output wires 42 is electrically connected with the contact module 30.

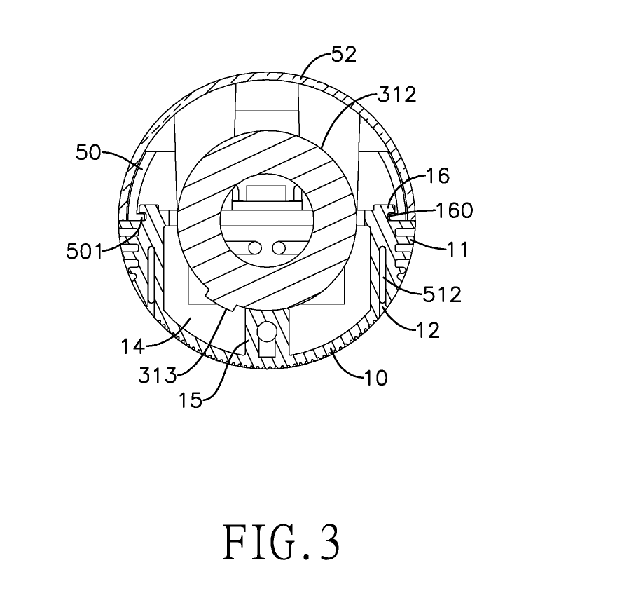

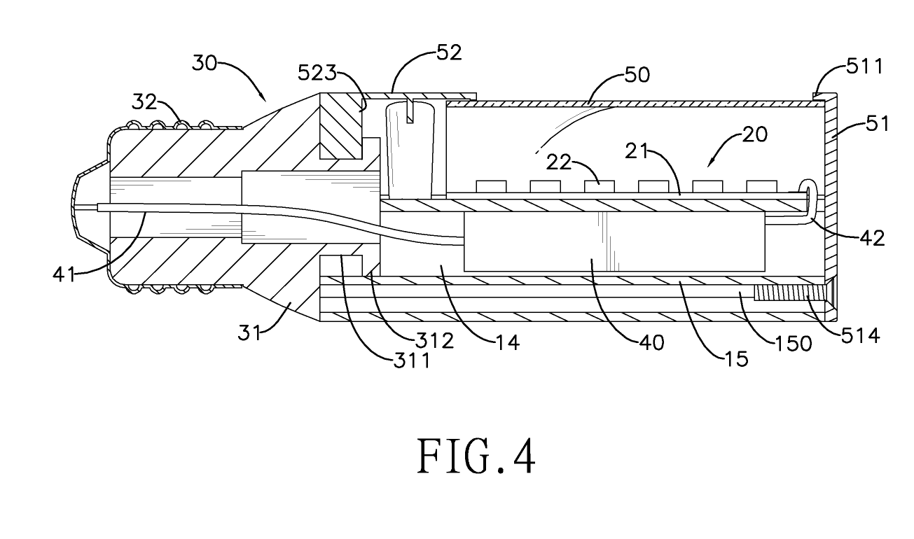

The contact module 30 has an insulation base 31 and a ring contact 32. The insulation base 31 has a cylinder, a neck 311, a ring 312 and a wire hole 314. The cylinder is formed on an end face of an outer side of the insulation base 31, and has an outer diameter corresponding to that of the ring contact 32 for the ring contact 32 to be mounted around the cylinder. The neck 311 and the ring 312 are coaxially formed on and protrude inwardly from an end face of an inner side of the insulation base 31. The outer diameter of the ring 312 is greater than that of the neck 311. The outer diameters of the neck 311 and the ring 312 respectively correspond to widths of the longitudinal slot and the transverse slot of the opening 132 on the platform 13 along the transverse direction so that the neck 311 and the ring 312 of the insulation base 31 can be mounted through the opening 132 and rotatable in the opening 132. With reference to FIG. 3, the ring 312 has a stop protrusion 313 formed on and protruding radially from a circumferential periphery of the ring 312, and blocked by the stop bar 15 when the insulation base 31 is rotated, so as to limit a rotation angle of the insulation base 31. Whether the insulation base 31 is rotated clockwise or counter-clockwise, the rotation angle of the insulation base 31 does not exceed 360 degrees. With reference to FIG. 4, the wire hole 314 is longitudinally formed through the insulation base 31 for the set of input wires 41 to be electrically connected with the ring contact 32 through the wire hole 314.

With reference to FIGS. 2 and 3, the lamp shade 50 takes the form of an arced sheet body, and has two channel clips 501 respectively and longitudinally formed on and protruding inwardly from two longitudinal edges of an inner wall of the lamp shade 50 and respectively corresponding to and clipped into the channels 160 of the guide strips 16.

After the lamp shade 50 is clipped on the heat-dissipating body 10, the first fixing member 51 and the second fixing member 52 are securely mounted on two ends of the lamp shade 50 along the longitudinal direction. The first fixing member 51 is disc-shaped, and has an arced flange 511, at least one insertion piece 512, a fixing hole 513 and a bolt 514. With reference to FIG. 4, the arced flange 511 is formed on and protrudes inwardly from a top circumference of the first fixing member 51, and is mounted around one arced edge of the lamp shade 50. The at least one insertion piece 512 is formed on an inner side of the first fixing member 51. In the present embodiment, the first fixing member 51 has two insertion pieces 512 corresponding to and mounted in the two notches 12 of the heat-dissipating body 10. The fixing hole 513 is formed through one semicircle of the first fixing member 51 not surrounded by the arced flange 511, and corresponds to the through hole 150 of the stop bar 15 of the heat-dissipating body 10. The bolt 514 is mounted through the fixing hole 513 and the through hole 150 of the stop bar 15 so as to fix the first fixing member 51 on one end of the heat-dissipating body 10 opposite to the contact module 30 and one end of the lamp shade 50.

The second fixing member 52 is mounted on the other end of the lamp shade 50. In the present embodiment, the second fixing member 52 takes the form of an arcuate block, and has two fixing holes 521, two bolts 522 and a limit block 523. The fixing holes 521 are formed through an arced periphery of the second fixing member 52, and respectively correspond to the positioning holes on the platform 13. The bolts 522 are respectively screwed into the positioning holes 17 on the platform 13 through the fixing holes 521 so as to fix the second fixing member 52 on one end of the platform 13 opposite to the first fixing member 51. An inner side of the second fixing member 52 abuts against the other end of the lamp shade 50. The limit block 523 is arcuate, is formed on and protrudes inwardly from an arced side of the second fixing member 52, corresponds to and is mounted around the neck 311 of the insulation base 31, and abuts against an outer side of the ring 312, so that the insulation base 31 can be pivotally mounted in the heat-dissipating body 10.

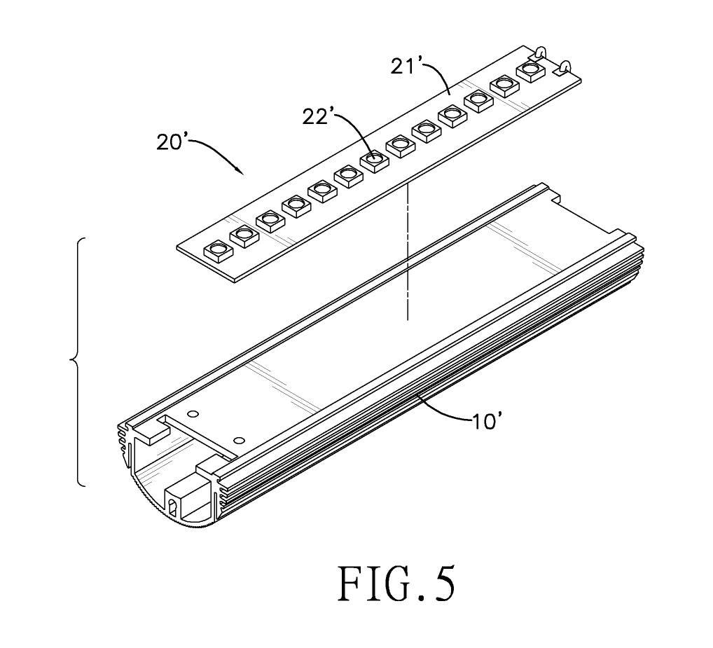

With the structure of the foregoing embodiment, the contact module 30 and the light source module 20 of the beam angle adjustable LED lamp can be easily pivoted relative to each other. After the beam angle adjustable LED lamp is mounted, the lighting angle thereof can still be adjusted to enhance a lighting efficiency of the LED lamp. On the other hand, as the heat-dissipating body 10 is made of extruded aluminum, the heat-dissipating bodies 10 having different lengths can be cut to meet corresponding heat-dissipating requirements. With reference to FIG. 5, a light source module 20′ having a different lighting specification is disclosed. The light source module 20′ has more LEDs 22′ mounted on a circuit board 21′ than the light source module 20 does in the foregoing embodiment. Under this circumstance, a heat-dissipating body 10′ that is longer than that in the foregoing embodiment is incorporated to increase a heat-dissipating area and a heat-dissipating efficiency of the heat-dissipating body 10′. Accordingly, in response to various heat-dissipating requirements, different heat-dissipating parts do not need to be die-casted beforehand, thereby effectively lowering the stocking pressure and the production cost of the LED lamp.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A beam angle adjustable LED lamp comprising:
a heat-dissipating body being tubular, composed of an extrusion, and having:
a platform formed on a periphery of the heat-dissipating body and having a surface; and
a chamber defined by the heat-dissipating body and located under the platform;
a light source module mounted on the platform of the heat-dissipating body to constitute a thermal contact with the surface of the platform;
a contact module having:
an insulation base pivotally mounted on one end of the heat-dissipating body; and
a ring contact mounted around the insulation base; and
a power converter mounted inside the chamber of the heat-dissipating body, and having:
one set of input wires electrically connected to the ring contact; and
one set of output wires electrically connected to the light source module.

2. The beam angle adjustable LED lamp as claimed in claim 1, wherein
the platform further has an opening formed through one end of the platform, being T-shaped, and having:
a transverse slot; and
a longitudinal slot, wherein one end of the longitudinal slot communicates with the transverse slot, and the other end is formed through an edge of the platform; and
the insulation base of the contact module has:
a cylinder formed on an outer side of the insulation base, and having an outer diameter corresponding to that of the ring contact for the ring contact to be mounted around the cylinder; and
a neck and a ring coaxially formed on and protruding inwardly from an inner side of the insulation base, wherein an outer diameter of the ring is greater than that of the neck, and the outer diameters of the neck and the ring respectively correspond to widths of the longitudinal slot and the transverse slot of the opening of the platform along a transverse direction so that the neck and the ring of the insulation base are pivotally mounted through the opening

3. The beam angle adjustable LED lamp as claimed in claim 2, wherein
the heat-dissipating body further has a stop bar longitudinally formed on and protruding from a bottom of an inner wall of the heat-dissipating body, and
the ring of the insulation base has a stop protrusion formed on and protruding radially from a circumferential periphery of the ring, and blocked by the stop bar when the insulation base rotates.

4. The beam angle adjustable LED lamp as claimed in claim 3, wherein the insulation base further has a wire hole longitudinally formed through the insulation base for the set of input wires of the power converter to be electrically connected with the ring contact through the wire hole.

5. The beam angle adjustable LED lamp as claimed in claim 4, wherein the light source module has:
a circuit board being elongated and mounted on the platform of the heat-dissipating body to constitute a thermal contact with the surface of the platform; and
multiple LEDs mounted on the circuit board.

6. The beam angle adjustable LED lamp as claimed in claim 3, wherein
the heat-dissipating body further has two guide strips respectively and longitudinally formed on two sides of the platform along the transverse direction, and having two respective sidewalls opposite each other, and two channels respectively and longitudinally formed in the sidewalls of the guide strips; and
the LED lamp further has a lamp shade, the lamp shade taking a form of an arced sheet body, and having two longitudinal edges and two channel clips respectively and longitudinally formed on and protruding inwardly from the longitudinal edges of the lamp shade and respectively corresponding to and clipped into the channels of the guide strips.

7. The beam angle adjustable LED lamp as claimed in claim 4, wherein
the heat-dissipating body further has two guide strips respectively and longitudinally formed on two sides of the platform along the transverse direction, and having two respective sidewalls opposite each other, and two channels respectively and longitudinally formed in the sidewalls of the guide strips; and
the LED lamp further has a lamp shade, the lamp shade taking a form of an arced sheet body, and having two longitudinal edges and two channel clips respectively and longitudinally formed on and protruding inwardly from the longitudinal edges of the lamp shade and respectively corresponding to and clipped into the channels of the guide strips.

8. The beam angle adjustable LED lamp as claimed in claim 5, wherein
the heat-dissipating body further has two guide strips respectively and longitudinally formed on two sides of the platform along the transverse direction, and having two respective sidewalls opposite each other, and two channels respectively and longitudinally formed in the sidewalls of the guide strips; and
the LED lamp further has a lamp shade, the lamp shade taking a form of an arced sheet body, and having two longitudinal edges and two channel clips respectively and longitudinally formed on and protruding inwardly from the longitudinal edges of the lamp shade and respectively corresponding to and clipped into the channels of the guide strips.

9. The beam angle adjustable LED lamp as claimed in claim 6, wherein
the at least one positioning hole is formed through the platform and adjacent to the opening; and
the LED lamp further has:
a first fixing member being disc-shaped, and having a top circumference and an arced flange formed on and protruding inwardly from the top circumference of the first fixing member to block one end of the lamp shade; and
a second fixing member taking a form of an arcuate block, and having:
an arced periphery;
an arced side;
two fixing holes formed through the arced periphery of the second fixing member, and respectively corresponding to the positioning holes on the platform;
two bolts respectively screwed into the positioning holes of the platform through the fixing holes of the second fixing member so that an inner side of the second fixing member abuts against the other end of the lamp shade; and
a limit block being arcuate, formed on and protruding inwardly from the arced side of the second fixing member, corresponding to and mounted around the neck of the insulation base, and abutting against an outer side of the ring.

10. The beam angle adjustable LED lamp as claimed in claim 7, wherein
the at least one positioning hole is formed through the platform and adjacent to the opening; and
the LED lamp further has:
a first fixing member being disc-shaped, and having a top circumference and an arced flange formed on and protruding inwardly from the top circumference of the first fixing member to block one end of the lamp shade; and
a second fixing member taking a form of an arcuate block, and having:
an arced periphery;
an arced side;
two fixing holes formed through the arced periphery of the second fixing member, and respectively corresponding to the positioning holes on the platform;
two bolts respectively screwed into the positioning holes of the platform through the fixing holes of the second fixing member so that an inner side of the second fixing member abuts against the other end of the lamp shade; and
a limit block being arcuate, formed on and protruding inwardly from the arced side of the second fixing member, corresponding to and mounted around the neck of the insulation base, and abutting against an outer side of the ring.

11. The beam angle adjustable LED lamp as claimed in claim 8, wherein
the at least one positioning hole is formed through the platform and adjacent to the opening; and
the LED lamp further has:
a first fixing member being disc-shaped, and having a top circumference and an arced flange formed on and protruding inwardly from the top circumference of the first fixing member to block one end of the lamp shade; and
a second fixing member taking a form of an arcuate block, and having:
an arced periphery;
an arced side;
two fixing holes formed through the arced periphery of the second fixing member, and respectively corresponding to the positioning holes on the platform;
two bolts respectively screwed into the positioning holes of the platform through the fixing holes of the second fixing member so that an inner side of the second fixing member abuts against the other end of the lamp shade; and
a limit block being arcuate, formed on and protruding inwardly from the arced side of the second fixing member, corresponding to and mounted around the neck of the insulation base, and abutting against an outer side of the ring.

12. The beam angle adjustable LED lamp as claimed in claim 9, wherein
the stop bar has a through hole longitudinally formed through the stop bar, and
the first fixing member further has:
a fixing hole formed through one semicircle of the first fixing member not surrounded by the arced flange, and corresponding to the through hole of the stop bar of the heat-dissipating body; and
a bolt mounted through the fixing hole of the first fixing member and the through hole of the stop bar so as to fix the first fixing member on the heat-dissipating body and the lamp shade.

13. The beam angle adjustable LED lamp as claimed in claim 10, wherein
the stop bar has a through hole longitudinally formed through the stop bar; and
the first fixing member further has:
a fixing hole formed through one semicircle of the first fixing member not surrounded by the arced flange, and corresponding to the through hole of the stop bar of the heat-dissipating body; and
a bolt mounted through the fixing hole of the first fixing member and the through hole of the stop bar so as to fix the first fixing member on the heat-dissipating body and the lamp shade.

14. The beam angle adjustable LED lamp as claimed in claim 11, wherein
the stop bar has a through hole longitudinally formed through the stop bar; and
the first fixing member further has:
a fixing hole formed through one semicircle of the first fixing member not surrounded by the arced flange, and corresponding to the through hole of the stop bar of the heat-dissipating body; and
a bolt mounted through the fixing hole of the first fixing member and the through hole of the stop bar so as to fix the first fixing member on the heat-dissipating body and the lamp shade.

15. The beam angle adjustable LED lamp as claimed in claim 12, wherein
the heat-dissipating body further has:
a semicircular section;
a semicylindrical periphery;
multiple fins oppositely and longitudinally formed on and transversely protruding from the semicylindrical periphery, each fin having an inner portion; and
two notches oppositely and longitudinally formed in the inner portions of the fins; and
the first fixing member further has at least one insertion piece formed on an inner side of the first fixing member and respectively mounted in the two notches of the heat-dissipating body.

16. The beam angle adjustable LED lamp as claimed in claim 13, wherein
the heat-dissipating body further has:
a semicircular section;
a semicylindrical periphery;
multiple fins oppositely and longitudinally formed on and transversely protruding from the semicylindrical periphery, each fin having an inner portion; and
two notches oppositely and longitudinally formed in the inner portions of the fins; and
the first fixing member further has at least one insertion piece formed on an inner side of the first fixing member and respectively mounted in the two notches of the heat-dissipating body.

17. The beam angle adjustable LED lamp as claimed in claim 14, wherein
the heat-dissipating body further has:
a semicircular section;
a semicylindrical periphery;
multiple fins oppositely and longitudinally formed on and transversely protruding from the semicylindrical periphery, each fin having an inner portion; and
two notches oppositely and longitudinally formed in the inner portions of the fins; and
the first fixing member further has at least one insertion piece formed on an inner side of the first fixing member and respectively mounted in the two notches of the heat-dissipating body.
